(19) United States
(12) Patent Application Publication
(10) Pub. No.: US 2025/0172990 A1
(43) Pub. Date: May 29, 2025

(54) SYSTEM-ON-CHIP AND POWER MANAGEMENT METHOD FOR SUCH A SYSTEM-ON-CHIP

(71) Applicant: STMicroelectronics International N.V., Geneva (CH)

(72) Inventors: Anne Joguet, St Egreve (FR); Sidiki Sylla, Grenoble (FR)

(21) Appl. No.: 18/959,060

(22) Filed: Nov. 25, 2024

(30) Foreign Application Priority Data
Nov. 27, 2023 (FR) 2313113

(51) Int. Cl. G06F 1/3296; G06F 1/3234; G06F 1/3287

(52) U.S. Cl. CPC G06F 1/3296; G06F 1/3243; G06F 1/3275; G06F 1/3287

(57) ABSTRACT

A system-on-chip includes a central processing unit, memories comprising a data memory and directly coupled to the central processing unit, where the memories store a first sequence of micro-instructions and a second sequence of micro-instructions to be executed in the central processing unit. The SoC includes a power supply controller configured to set the central processing unit and the memories in a normal operation power supply mode in which the central processing unit and the memories are powered by a normal operation supply voltage, or in a standby power supply mode in which the central processing unit is no longer powered and the memories are powered by a standby supply voltage lower than the normal operation supply voltage and sufficient to preserve data stored in the memories. The central processing unit is configured to execute the first sequence of micro-instructions before being set in a standby power supply mode, and execute the second sequence of micro-instructions when leaving the standby power supply mode.

### CROSS-REFERENCE TO RELATED APPLICATIONS

This application claims the benefit of French Application No. 2313113, filed on Nov. 27, 2023, which application is hereby incorporated herein by reference.

### TECHNICAL FIELD

The present invention relates generally to systems-on-chip, and in particular embodiments, to optimization of the energy consumption of such systems-on-chip.

### BACKGROUND

Systems-on-chip are commonly used in a wide variety of electronic apparatuses, such as “smartphones,” digital tablets, laptops, embedded systems, connected objects (IoT), inter alia.

A system-on-chip (also referred to by the acronym “SoC”) is an electronic component that incorporates several essential elements of a computer or electronic system on one single silicon chip. For example, a system-on-chip comprises a central processing unit, a memory and communication interfaces on one single chip.

The optimization of the energy consumption of a system-on-chip is of high importance in order to avoid consuming energy uselessly. In particular, the system-on-chip may be powered by a battery having a limited capacity. Hence, the energy consumption stored in this battery should be limited as best as possible in order to increase the duration of use of the system-on-chip between two recharges of the battery.

In order to optimize the energy consumption of a system-on-chip, the system-on-chip may comprise several power supply domains. The power supply domains correspond to areas of the system-on-chip which are distinct and electrically isolated. These power supply domains allow independently powering different functional blocks or subsystems of the system-on-chip. Thus, the use of power supply domains allows managing the energy consumption more efficiently and controlling the power supply of the elements of the system-on-chip according to their use or their operation state.

In particular, the power supply fields allow controlling and managing the electric power supply of the elements of the system-on-chip in a selective manner, by adapting the electric power supply of these elements according to their needs. Thus, it is possible to reduce the energy consumption when some elements of the system-on-chip are not used.

The management of the power supply of the different elements of the system-on-chip may be ensured by an energy management system.

In particular, a system-on-chip may comprise a power supply domain associated with its central processing unit and a power supply domain associated with its energy management system.

It is essential to optimize the energy consumption of the system-on-chip when the central processing unit is inactive. In particular, the central processing unit may be made inactive during the execution of a computer program. It is then essential to be able to stop the electric power supply of the central processing unit while preserving the execution context of the interrupted computer program in order to be able to recover it to resume the execution of the computer program once the electric power supply of the central processing unit has been re-established.

In this respect, software solutions allowing stopping the electric power supply of a central processing unit while preserving the execution context of the interrupted computer program are known. Nevertheless, these software solutions are generally complex and require the execution of a large number of instructions. Thus, the storage and recovery of the execution context may be relatively slow.

It is also possible to use flip-flops to preserve the execution context when the electric power supply of the central processing unit is interrupted during the execution of a computer program. Nevertheless, such flip-flops have the drawback of occupying a large space in the system-on-chip.

### SUMMARY

In accordance with an embodiment, a system-on-chip includes a central processing unit, memories directly coupled to the central processing unit, a power supply controller configured to set the central processing unit and the memories: in a normal operation power supply mode in which the central processing unit and the memories are powered by a normal operation supply voltage, or in a standby power supply mode in which the central processing unit is no longer powered and the memories are powered by a standby supply voltage lower than the normal operation supply voltage and sufficient to preserve data stored in the memories. The central processing unit is configured to execute a first sequence of micro-instructions before being set in a standby power supply mode, the first sequence of micro-instructions being configured to copy, in at least one data memory directly coupled to the central processing unit, an execution context of a computer program the execution of which by the central processing unit is interrupted to switch into a standby power supply mode, and execute a second sequence of micro-instructions when leaving the standby power supply mode to recover the execution context stored in the memories in order to resume the execution of the interrupted computer program.

In accordance with an embodiment, an electric power management method for a system-on-chip includes setting, by a power supply controller, a central processing unit and memories in a normal operation power supply mode in which the central processing unit and the memories are powered by a normal operation supply voltage. The system-on-chip includes the central processing unit, the memories being directly coupled to the central processing unit, and the power supply controller. The method includes executing by the central processing unit a first sequence of micro-instructions before being set in a standby power supply mode, the first sequence of micro-instructions being configured to copy, in at least one data memory directly coupled to the central processing unit, an execution context of a computer program the execution of which by the central processing unit is interrupted to switch into a standby power supply mode. The method includes setting, by the power supply controller, the central processing unit and the memories in the standby power supply mode in which the central processing unit is not powered and the memories are powered by a standby supply voltage lower than the normal operation supply voltage and sufficient to preserve data stored in the memories. The method includes setting, by the power supply controller, the central processing unit and the memories back to the normal operation power supply mode. The method includes executing by the central processing unit a second sequence of micro-instructions when leaving the standby power supply mode to recover the execution context stored in the memories in order to resume the execution of the interrupted computer program.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a system-on-chip SOC;

FIG. 2 illustrates an electric power supply management method of a system-on-chip SOC such as that one described before;

FIG. 3 illustrates the state of the registers REGF, CSR, PPR of the central processing unit CPU as well as the state of the memories TCM before switching into the standby power supply mode;

FIG. 4 illustrates the preservation of the execution context in the standby power supply mode; and

FIG. 5 illustrates the recovery of the execution context when leaving the standby power supply mode.

### DETAILED DESCRIPTION OF ILLUSTRATIVE EMBODIMENTS

Hence, it would be advantageous to allow interrupting the electric power supply of the central processing unit of a system-on-chip during the execution of a computer program and then restarting this central processing unit relatively rapidly once its electric power supply is resumed.

It would also be advantageous to have a limited impact on the size of the system-on-chip.

According to one aspect, a system-on-chip is provided comprising: a central processing unit, memories directly coupled to the central processing unit, a power supply controller configured to set the central processing unit and the memories: in a normal operation power supply mode in which the central processing unit and the memories are powered by a normal operation supply voltage, or in a standby power supply mode in which the central processing unit is no lower powered and the memories are powered by a standby supply voltage lower than the normal operation supply voltage and sufficient to preserve data stored in the memories, and wherein the central processing unit is configured to: execute a first sequence of micro-instructions—in particular injected, through the execution of an instruction “goto_retention”, into a processing chain of the central processing unit—before being set in a standby power supply mode, the first sequence of micro-instructions being adapted to copy, in at least one data memory directly coupled to the central processing unit, an execution context of a computer program the execution of which by the central processing unit is interrupted to switch into a standby power supply mode, execute a second sequence of micro-instructions—in particular injected, through the execution of an instruction “release_retention”, into the processing chain of the central processing unit—when leaving the standby power supply mode to recover the execution context stored in the memories in order to resume the execution of the interrupted computer program.

Hence, such a system-on-chip uses memories directly coupled to the central processing unit to store the execution context of a computer program executed by this central processing unit before switching into the standby power supply mode.

Thus, when the central processing unit is inactive, it is possible to stop the electric power supply of the central processing unit while maintaining a sufficient electric power supply for the memories directly coupled to the central processing unit in order to preserve the execution context until resumption of the electric power supply of the central processing unit. This allows considerably reducing the energy consumption of the system-on-chip.

Furthermore, keeping the execution context in the memories directly coupled to the central processing unit enables a simple and rapid restoration of the execution context of the interrupted computer program once the electric power supply of the central processing unit has been re-established. Hence, the execution of the computer program can be resumed rapidly after having re-established the electric power supply of the central processing unit.

Such a system-on-chip also has the advantage that the storage and the recovery of the execution context in the memories directly coupled to the central processing unit for switching into and leaving the standby power supply mode are performed by a state machine of the central processing unit and not by software means. This allows carrying out switching into and leaving the standby power supply mode more simply and more rapidly. This also allows ensuring that the entire execution context is properly stored and recovered in the at least one data memory directly coupled to the central processing unit. In particular, such a system-on-chip is configured to restore information on the context in read-only registers which can be modified only by hardware means and not by software means.

Such a system-on-chip also has the advantage of not using additional and cumbersome low-power components such as flip-flops to preserve the execution context of the interrupted computer program.

In an advantageous embodiment, the central processing unit comprises a power supply mode controller configured to communicate with the power supply controller in order to negotiate with the power supply controller a switch into a standby power supply mode.

Advantageously, the central processing unit comprises a control unit configured to execute a state machine allowing executing micro-instructions to: store the execution context in the at least one data memory directly coupled with the central processing unit before switching into the standby power supply mode, recover the execution context in the at least one data memory directly coupled with the central processing unit when leaving the standby power supply mode.

Preferably, the central processing unit is configured to execute instructions to enter and leave the standby power supply mode—in particular the instruction “goto_retention” to enter the standby power supply mode and the instructions “luiX2/addX2”, “release_retention” and “mret” to leave the standby power supply mode—, these instructions being stored in at least one program memory directly coupled with the central processing unit.

Advantageously, the central processing unit further comprises a register configured to store an auxiliary stack pointer configured to store the value of a main stack pointer before switching into a standby power supply mode, the first sequence of micro-instructions being configured to store the auxiliary stack pointer in the at least one data memory directly coupled to the central processing unit before switching into the standby power supply mode, the second sequence of micro-instructions being configured to recover the value of the auxiliary stack pointer to use it as a main stack pointer.

In an advantageous embodiment, the power supply controller is configured to transmit, when leaving the standby power supply mode, a signal allowing indicating to the central processing unit that the latter is returning from a standby power supply mode, so that the central processing unit executes the second sequence of micro-instructions.

According to another aspect, an electric power management method for a system-on-chip as described before is provided, the method comprises executing by the central processing unit a first sequence of micro-instructions—in particular injected, through the execution of an instruction “goto_retention”, into a processing chain of the central processing unit—before being set in a standby power supply mode, the first sequence of micro-instructions being adapted to copy, in at least one data memory directly coupled to the central processing unit, an execution context of a computer program the execution of which by the central processing unit is interrupted to switch into a standby power supply mode. The method comprises executing by the central processing unit a second sequence of micro-instructions—in particular injected, through the execution of an instruction “release_retention”, into the processing chain of the central processing unit—when leaving the standby power supply mode to recover the execution context stored in the memories in order to resume the execution of the interrupted computer program.

In an advantageous implementation, the method comprises a communication between a standby mode controller of the central processing unit and the power supply controller in order to negotiate a switch into a standby power supply mode.

Advantageously, the method comprises executing by the central processing unit micro-instructions supplied by a state machine of a control unit of the central processing unit to: store the execution context in the at least one data memory directly coupled with the central processing unit before switching into the standby power supply mode, recover the execution context in the at least one data memory directly coupled with the central processing unit when leaving the standby power supply mode.

Preferably, the method comprises executing, by the central processing unit, instructions—in particular the instructions “goto_retention”, “luiX2/addX2”, “release_retention” and “mret”—to enter and leave the standby power supply mode, these instructions being stored in at least one program memory directly coupled with the central processing unit.

Advantageously, the method further comprises storing an auxiliary stack pointer in a register of the central processing unit, the auxiliary stack pointer allowing storing the value of a main stack pointer executed before switching into a standby power supply mode, the execution of the first sequence of micro-instructions allowing storing the auxiliary stack pointer in the at least one data memory directly coupled to the central processing unit before switching into the standby power supply mode, the execution of the second sequence of micro-instructions allowing recovering the value of the auxiliary stack pointer to use it as a main stack pointer.

In an advantageous implementation, the method further comprises, when leaving the standby power supply mode, transmitting by the power supply controller a signal allowing indicating to the central processing unit that the latter is returning from a standby power supply mode, so that the central processing unit executes the second sequence of micro-instructions.

Other advantages and features of the invention will appear upon examining the detailed description of some non-limiting embodiments, and from the appended drawings, wherein:

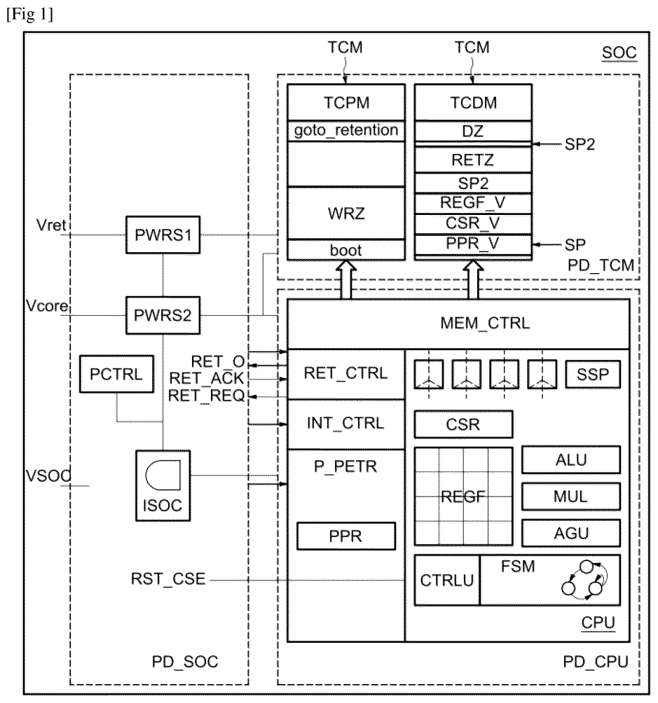

FIG. 1 illustrates a system-on-chip SOC.

The system-on-chip SOC comprises a central processing unit CPU, a power supply controller PCTRL, memories TCM directly coupled to the central processing unit CPU (these memories could also be referred to by the expression “tightly coupled memories”).

The central processing unit CPU is configured to execute instructions of a computer program, in particular of the “firmware” type.

In particular, the central processing unit CPU comprises elements that are well-known to a person skilled in the art, such as an arithmetic and logic unit ALU, an address generation unit AGU, a multiplication/division unit MUL, etc.

The system-on-chip SOC uses several power supply modes allowing adapting its energy consumption according to the use of the different elements of this system-on-chip SOC. The system-on-chip SOC is divided into several power supply domains allowing adapting the power supply independently between the different power supply domains.

In particular, the system-on-chip comprises a first power supply domain PD_SOC containing the power supply controller PCTRL.

The system-on-chip SOC comprises a second power supply domain PD_CPU containing the central processing unit CPU.

The system-on-chip SOC comprises a third power supply domain PD_TCM containing the memories TCM.

The central processing unit CPU may be set in different power supply modes.

In particular, the central processing unit CPU may be set in a normal operation power supply mode. In this mode, the central processing unit CPU is powered by a voltage Vcore.

The central processing unit CPU may also be set in an inactivity power supply mode. In this mode, the central processing unit CPU is no longer powered.

The central processing unit CPU may also be set in a standby power supply mode. In this mode, the central processing unit CPU is no longer powered but is configured to save the execution context of the program before its power supply is cut off.

The switch from the normal operation power supply mode into the standby power supply mode is done by executing a “goto_retention” instruction capable of injecting micro-instructions into a processing chain (“pipeline”) of the central processing unit CPU.

The central processing unit CPU comprises a register bank REGF (or “register file”). The register bank REGF is used to temporarily store data during processing of instructions by the central processing unit CPU during an execution of a computer program.

The central processing unit CPU comprises a memory controller coupled with the memories TCM. The memories TCM are memories that are directly coupled and juxtaposed to the central processing unit CPU. The memories TCM are configured to provide rapid access for the central processing unit, in particular more rapid compared to an external memory RAM or other types of memories further away from the central processing unit. Thus, these memories TCM allow improving the performances of a computer program executed by the central processing unit CPU by reducing the times of access to the memory. The memories TCM also have a low latency, i.e. the duration elapsed between a request for access to the memory and a provision of the data by the memory. In particular, the latency of the memories TCM is in the range of one cycle of the central processing unit. Each memory TCM has a peripheral circuit and an array. The array is used to record data or instructions. The peripheral circuit is used for the operation of the memory TCM. The peripheral circuit and the array may receive two different voltages for the same power supply mode.

The memories TCM may be set in a normal operation power supply mode or in a standby power supply mode. In the normal operation power supply mode, the peripheral circuit and the array of each memory TCM are powered by a voltage Vcore. In the standby power supply mode, the periphery of each memory TCM is not powered but the array of each memory TCM is powered by a voltage Vret to keep the information contained therein. The voltage Vret is a voltage lower than the voltage Vcore. The voltage Vret is adapted so as to be lower than the voltage Vcore but sufficient to enable a preservation of the data in the memories TCM, and more particularly to preserve an execution context, as described later on. For example, the voltage Vret is in the range of 0.6 Volts.

The memories TCM comprise a program memory TCPM and a data memory TCDM. The program memory TCPM is configured to store instructions of a computer memory executed by the central processing unit. The central processing unit uses an instruction pointer pointing on the instructions to be executed stored in the program memory TCPM during the execution of a computer program.

The data memory TCDM comprises a main stack (area DZ of the data memory TCDM) configured to store data generated during the execution of a computer program, in particular temporary data derived from the register bank REGF. The central processing unit also uses a main stack pointer SP pointing towards addresses of the main stack of the data memory TCDM.

This main stack allows saving the content of the register bank REGF when changing the execution context. This content is re-established in the register bank REGF when restoring the execution context. The main stack pointer SP then points towards the address of the last piece of data saved in the area DZ of the data memory TCDM.

Moreover, the data memory TCDM is also configured to have a standby area RETZ. This standby area RETZ is used to store an execution context of the program before the central processing unit CPU switches into the standby mode. The standby area RETZ starts at an address “retention_context_address” known to the control unit CTRLU of the central processing unit CPU.

The central processing unit CPU further comprises control and status registers CSR (“control and status register”). The registers CSR are configured to store operating parameters of the central processing unit CPU as well as information on the state of the central processing unit CPU.

The central processing unit CPU also comprises an interface P_PETR for private peripherals. This interface P_PETR comprises registers PPR for the private peripherals. The registers PPR for the private peripherals allow configuring and controlling the operation of peripherals of the system-on-chip, such as an interruption controller, a memory protection unit, etc.

The central processing unit CPU further comprises a control unit CTRLU. The control unit CTRLU is configured to implement a state machine FSM, allowing injecting micro-instructions into the processing chain of the central processing unit, before the central processing unit CPU switches into the standby power supply mode and when leaving the latter. In particular, the instruction “goto_retention” is executed before switching into the standby power supply mode. The instruction “goto_retention” allows implementing the state machine FSM to inject a sequence of micro-instructions into the processing chain of the central processing unit CPU. This sequence of micro-instructions allows saving the execution context of the computer program in a memory TCM before switching into the standby power supply mode.

Upon leaving the standby power supply mode, the central processing unit CPU executes a series of micro-instructions injected by a state machine FSM in the processing chain of the central processing unit. This series of micro-instructions allow recovering the execution context of the interrupted computer program in order to resume the execution of this computer program.

The execution context corresponds to all of the data used by the computer program that need to be saved to enable an interruption of the computer program and then a resumption of execution thereof at the point where the computer program has been interrupted. The execution context comprises the data stored in the register bank REGF, those stored in the control and status registers CSR and those stored in the registers PPR for the private peripherals.

The central processing unit CPU also comprises a register SSP configured to store an auxiliary stack pointer (“Shadow stack pointer”). The auxiliary stack pointer takes on the value of the main stack pointer towards the area of the data memory TCDM in which the execution context of the interrupted computer program is stored, before switching into the standby power supply mode. Thus, the register SSP allows storing an auxiliary stack pointer SP2 pointing the address of the main stack pointer before proceeding with saving the execution context in the data memory TCDM. The sequence of micro-instructions injected by the state machine is configured to carry out a storage of this auxiliary stack pointer SP2 in the standby area RETZ of the data memory TCDM before switching into the standby power supply mode. The storage of this auxiliary stack pointer SP2 allows recovering, upon leaving the standby power supply mode, the address of the main stack pointer corresponding to the address of the top of the area DZ of the data memory TCDM storing the temporary data generated during the execution of the computer program before switching into the standby power supply mode.

The program memory TCPM also comprises an area WRZ in which instructions are stored allowing leaving the standby power supply mode by recovering the execution context of the interrupted program and then by performing plugging towards the instruction that follows the last instruction of the computer program executed before switching into the standby power supply mode. This area WRZ starts at an address “warm_restart_addr[31:0]”. In particular, the control unit CTRLU knows a boot address “boot_address_i[31:0]” as well as an offset value allowing obtaining the address “warm_restart_addr[31:0]” by adding it to the boot address.

In particular, this area WRZ of the program memory TCPM comprises instructions “luiX2/addX2” allowing loading the value of the end of the standby area in a register X2 of the register bank.

This area WRZ of the program memory TCPM also comprises a “release_retention” instruction. This instruction allows recovering the execution context of the interrupted program stored in the data memory TCDM. In particular, this instruction “release_retention” allows recovering the data stored in the standby area of the program memory TCPM which are associated with the register bank REGF, with the control and status registers CSR and with the registers PPR for the peripherals in order to re-establish these data in the corresponding registers. The instruction “release retention” is also configured to decrement the stack pointer loaded by the instruction “luiX2/addX2” in the register X2 of the register bank.

This area WRZ of the program memory TCPM also comprises an instruction “mret”. This instruction allows recovering the value of the instruction pointer (“program counter”) stored in the data memory TCDM to use it for the instruction pointer in order to perform plugging onto the instruction that follows the last instruction of the computer program executed before switching into the standby power supply mode.

The central processing unit CPU also comprises an interruption controller INT_CTRL. The interruption controller is configured to receive interruption signals. The interruption signals may allow stopping the execution of a computer program.

The central processing unit CPU comprises a power supply mode controller RET_CTRL. The power supply mode controller RET_CTRL is configured to communicate with the power supply controller PCTRL.

The power supply controller PCTRL is contained in the first power supply domain. All of the elements of the first power supply domain are constantly powered by a voltage VSOC.

The power supply controller PCTRL is configured to control the power supply of the different power supply domains of the system-on-chip.

In particular, the system-on-chip SOC is configured to generate the voltage VSOC, the standby voltage Vret and the power supply voltage Vcore. These voltages are generated from a power supply source, in particular a power generator of the system-on-chip SOC.

The system-on-chip SOC comprises a first power supply switch PWRS1 and a second power supply switch PWRS2 comprised in the power supply domain PD_SOC.

The first switch PWRS1 is controlled by the power supply controller PCTRL. The first switch PWRS1 is configured to receive the voltage Vret and to output, or not, this voltage Vret in the power supply domain PD_TCM according to a command of the power supply controller PCTRL. In particular, the first switch outputs the voltage Vret only when the system-on-chip SOC is in a standby mode.

The second switch PWRS2 is controlled by the power supply controller PCTRL. The second switch PWRS2 is configured to receive the voltage Vcore and then to output, or not, this voltage Vcore to the power supply domains PD_TCM and PD_CPU according to a command of the power supply controller PCTRL. In particular, the second switch PWRS2 outputs the voltage Vcore only when the system-on-chip SOC is in a normal operation power supply mode.

The power supply controller PCTRL is configured to receive a signal RET_REQ emitted by the power supply mode controller RET_CTRL of the central processing unit CPU when the central processing unit CPU asks the power supply controller PCTRL to switch into a standby mode.

The power supply controller PCTRL is configured to transmit a signal RET_ACK to the power supply mode controller RET_CTRL of the central processing unit CPU when the power supply controller PCTRL accepts to switch the central processing unit CPU into a standby mode after having received the signal RET_REQ.

The power supply controller PCTRL is configured to receive a signal RET_O emitted by the power supply mode controller RET_CTRL of the central processing unit CPU when the central processing unit CPU receives the signal RET_ACK. The power supply controller PCTRL is configured to switch the central processing unit CPU into the standby mode after having received the signal RET_O

The power supply controller PCTRL is also configured to transmit a signal RST_CSE to the central processing unit CPU when the power supply controller PCTRL switches the central processing unit CPU into a normal operation mode after having been in a standby mode. The signal RST_CSE allows indicating to the control unit CTRLU of the central processing unit CPU to perform a standby mode leaving procedure to recover the execution context of the interrupted program.

The system-on-chip SOC also comprises isolation cells ISOC. These isolation cells ISOC are comprised in the power supply domain PD_SOC. The isolation cells allow isolating the domain PD_CPU from the rest of the system-on-chip SOC when its electric power supply is interrupted. In particular, the isolation cells allow preventing a propagation of floating signals originating from the central processing unit when the latter is no longer electrically powered towards other elements of the system-on-chip SOC.

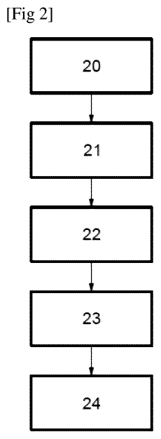

FIG. 2 illustrates an electric power supply management method of a system-on-chip SOC such as that one described before. In particular, the power supply management method allows switching into a standby power supply mode and then returning into a normal operation power supply mode.

Before switching into the standby power supply mode, in step 20, the central processing unit CPU operates normally and executes a computer program, in particular of the “firmware” type. Hence, the central processing unit CPU and the memories TCM are set in a normal operation power supply mode NORM_M. Thus, the power supply controller PCTRL controls the second switch PWRS2 so that the central processing unit CPU is powered by the voltage Vcore.

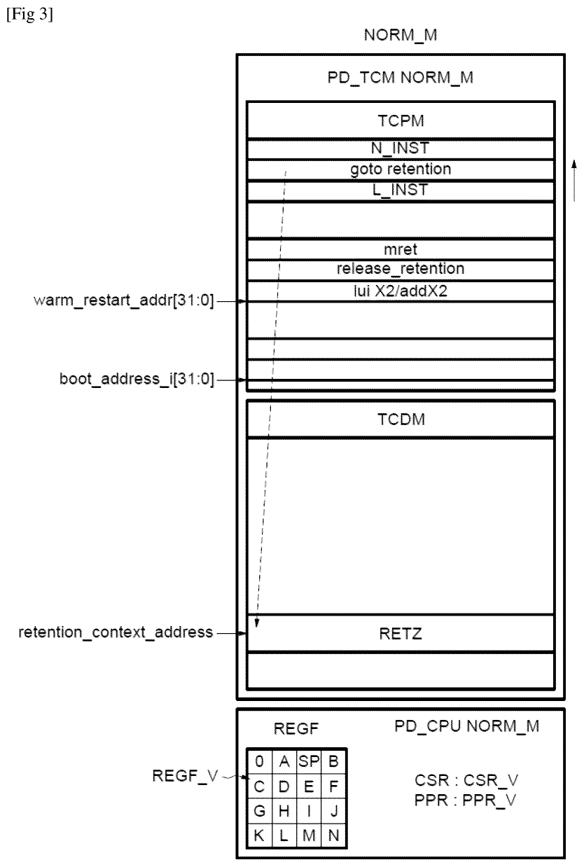

FIG. 3 illustrates the state of the registers REGF, CSR, PPR of the central processing unit CPU as well as the state of the memories TCM before switching into the standby power supply mode.

Afterwards, in step 21, the computer program receives an interruption causing a stoppage of the execution of the computer program and the execution of the instruction “goto_retention”. The interruption may originate from a peripheral of the system-on-chip SOC. Alternatively, the instruction “goto_retention” may be present in the executable code of the computer program and be executed during the execution of the computer program.

The instruction “goto_retention” allows injecting a sequence of micro-instructions into the processing chain of the central processing unit CPU.

In particular, this sequence of instructions is executed once all of the pending memory accesses are completed.

The sequence of micro-instructions injected by the instruction “goto_retention” by implementing the state machine FSM allows deactivating handling of the interruptions by the interruption controller INT_CTRL of the central processing unit CPU, in order to avoid any interruption when switching into the standby power supply mode.

The execution of the sequence of micro-instructions causes a storage of the execution context of the interrupted program in the standby area RETZ of the data memory TCDM. In particular, the execution of the sequence of micro-instructions causes a storage of the values REGF_V of the register bank REGF, of the values CSR_V of the control and status registers CSR and of the values PPR_V of the registers PPR for the peripherals.

This sequence of micro-instructions allows, afterwards, generating the signal RET_REQ by the power supply mode controller RET_CTRL and transmitting it to the power supply controller PCTRL.

Afterwards, the power supply controller PCTRL waits for the system-on-chip SOC to be ready to switch into a standby power supply mode and then generates the signal RET_ACK and transmits it to the power supply mode controller PCTRL of the central processing unit CPU.

Once the signal RET_ACK has been received, the execution of the sequence of micro-instructions allows, afterwards, generating the signal RET_O by the power supply mode controller RET_CTRL and transmitting it to the power supply controller PCTRL. This signal RET_O allows indicating that the central processing unit is ready to switch into the standby power supply mode.

In step 22, once the signal RET_O has been received, the power supply controller PCTRL switches the central processing unit CPU and the memories TCM into a retention power supply mode. To do so, the power supply controller PCTRL controls the first power supply switch PWRS1 so as to output the voltage Vret to the memories TCM. The power supply controller PCTRL also controls the second power supply switch PWRS2 so as to stop powering the central processing unit CPU.

The power supply controller PCTRL also stops the time stamp signal and forces a reset of the central processing unit CPU with the reset signal (“reset”).

The power supply controller also controls the isolation cells ISOC to isolate the central processing unit CPU.

Thus, the central processing unit CPU and the memories TCM are set in a standby power supply mode RET_M. In particular, the central processing unit CPU is not powered and the memories TCM are powered by the voltage Vret. Thus, the data of the register bank REFF, the data of the control and status registers CSR and the data of the registers PPR for the peripherals are cleared but kept in the standby area RETZ of the data memory TCDM.

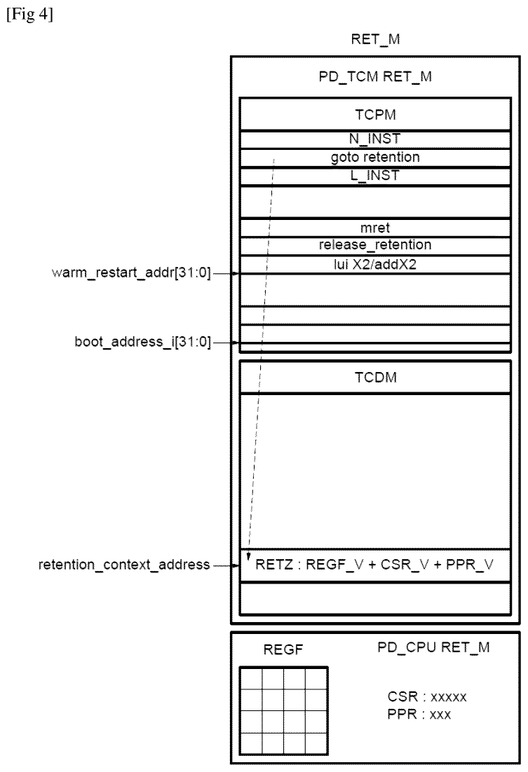

FIG. 4 illustrates the preservation of the execution context in the standby power supply mode.

Afterwards, in step 23, the power supply controller PCTRL can make the central processing unit CPU and the memories TCM leave the standby power supply mode depending on the needs of the system-on-chip SOC. In particular, leaving the standby power supply mode is carried out when a new data sequence of a peripheral of the system-on-chip SOC should be processed by the central processing unit.

In order to leave the standby power supply mode, the power supply controller PCTRL controls the first switch PWRS1 and the second switch PWRS2 to output the voltage Vcore to the central processing unit CPU and to the memories TCM. The central processing unit CPU and the memories TCM then switch into a normal operation power supply mode NORM_M.

The power supply controller PCTRL also re-establishes the clock signal and the reset signal.

The power supply controller PCTRL also controls the isolation cells ISOC to stop the isolation of the central processing unit CPU.

The power supply controller PCTRL also transmits a signal RST_CSE to the central processing unit. This signal RST_CSE allows indicating to the central processing unit CPU that is leaving a standby power supply mode. The central processing unit CPU could then implement a procedure for leaving the standby power supply mode. This procedure is implemented through the execution of power supply mode return functions. In particular, a state machine FSM of the control unit CTRLU is configured to inject into the processing chain (“pipeline”) of the central processing unit CPU a sequence of micro-instructions of the instruction “release_retention”. Afterwards, this sequence of micro-instructions is executed by the central processing unit CPU.

In particular, the instruction “release_retention” is executed to recover the data stored in the standby area RETZ of the data memory TCDM, i.e. the execution context of the interrupted computer program. As indicated before, some data REGF_V are associated with the register bank REGF, other data CSR_V are associated with the control and status registers CSR, and also other data PPR_V are associated with the registers PPR for the peripherals. These data are recovered and then respectively copied in the register bank REGF, in the control and status registers CSR and in the registers PPR for the peripherals. Furthermore, the value of the main stack pointer is modified by taking on the value of the auxiliary stack pointer stored in the standby area RETZ so that the main stack pointer points towards the address at the top of the area DZ of the data memory TCDM. The value of the instruction pointer is also recovered and stored in the control and status registers CSR.

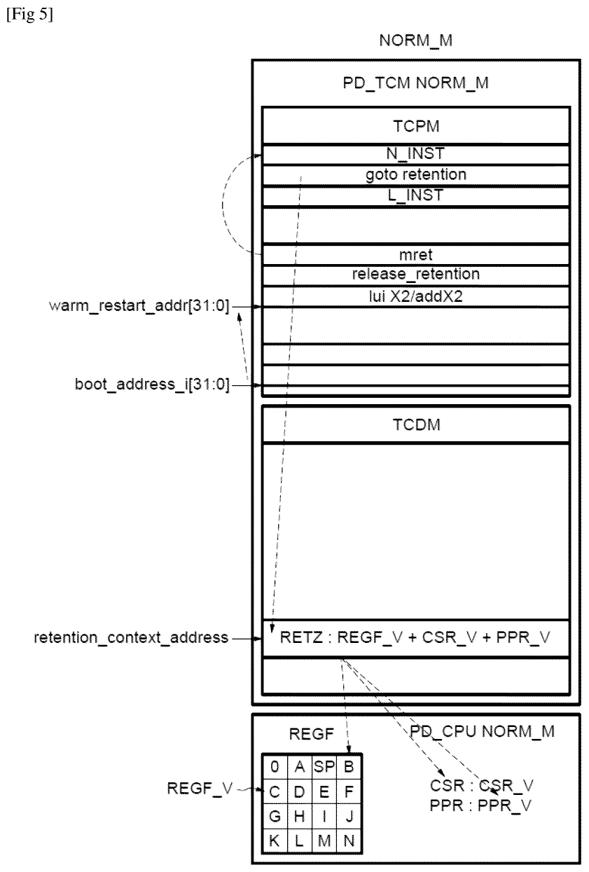

FIG. 5 illustrates the recovery of the execution context when leaving the standby power supply mode.

Then, the instruction “mret” is executed to recover the instruction pointer from the control and status registers CSR in order to re-establish the execution of the computer program from the address of the instruction N_INST that followed the last instruction L_INST of the computer program executed before switching the central processing unit into the standby power supply mode.

Afterwards, handling of the interruptions by the interruption controller INT_CTRL is re-established.

Afterwards, the execution of the computer program can be resumed in step 24.

The system-on-chip and the previously-described method use memories that are directly coupled to the central processing unit to store the execution context of a computer program executed by this central processing unit before switching into the backup power supply mode.

Thus, when the central processing unit is inactive, it is possible to stop the electric power supply of the central processing unit while keeping a sufficient electric power supply for the memories directly coupled to the central processing unit in order to preserve the execution context until resumption of the electric power supply of the central processing unit. This allows considerably reducing the energy consumption of the system-on-chip.

Furthermore, the preservation of the execution context in the memories directly coupled to the central processing unit enables a simple, rapid, complete and exact restoration of the execution context of the interrupted computer program once the electric power supply of the central processing unit has been re-established. Hence, the execution of the computer program can be resumed rapidly after having re-established the electric power supply of the central processing unit.

The system-on-chip and the previously-described method also have the advantage that the storage and the recovery of the execution context in the memories directly coupled to the central processing unit for switching into and leaving the standby power supply mode are performed by a state machine of the central processing unit and not by software means. This allows carrying out switching into and leaving the standby power supply mode more simply and more rapidly and accurately. In particular, this allows ensuring that the entire execution context is properly stored and recovered in the at least one data memory directly coupled to the central processing unit. In particular, such a system-on-chip is configured to restore information on the context in read-only registers which can be modified only by hardware means and not by software means.

The system-on-chip also has the advantage of not using additional and cumbersome low-power components such as flip-flops to preserve the execution context of the interrupted computer program.

What is claimed is:

1. A system-on-chip comprising:
a central processing unit,
memories comprising a data memory and directly coupled to the central processing unit, the memories storing a first sequence of micro-instructions and a second sequence of micro-instructions to be executed in the central processing unit,
a power supply controller configured to set the central processing unit and the memories:
in a normal operation power supply mode in which the central processing unit and the memories are powered by a normal operation supply voltage, or in a standby power supply mode in which the central processing unit is no longer powered and the memories are powered by a standby supply voltage lower than the normal operation supply voltage and sufficient to preserve data stored in the memories, and
wherein the central processing unit is configured to:
execute the first sequence of micro-instructions before being set in a standby power supply mode, the first sequence of micro-instructions comprising instructions to copy, in the data memory directly coupled to the central processing unit, an execution context of a computer program the execution of which by the central processing unit is interrupted to switch into a standby power supply mode, and
execute the second sequence of micro-instructions when leaving the standby power supply mode to recover the execution context stored in the memories in order to resume the execution of the interrupted computer program.

2. The system-on-chip according to claim 1, wherein the central processing unit comprises a power supply mode controller configured to communicate with the power supply controller in order to negotiate with the power supply controller a switch into a standby power supply mode.

3. The system-on-chip according to claim 1, wherein the central processing unit comprises a control unit configured to execute a state machine allowing executing micro-instructions to:
store the execution context in the data memory directly coupled with the central processing unit before switching into the standby power supply mode, and
recover the execution context in the data memory directly coupled with the central processing unit when leaving the standby power supply mode.

4. The system-on-chip according to claim 1, wherein the central processing unit is configured to execute instructions to enter and leave the standby power supply mode, these instructions being stored in one of the memories.

5. The system-on-chip according to claim 1, wherein the central processing unit further comprises a register configured to store an auxiliary stack pointer configured to store a value of a main stack pointer before switching into a standby power supply mode, the first sequence of micro-instructions being configured to store the auxiliary stack pointer in the data memory directly coupled to the central processing unit before switching into the standby power supply mode, the second sequence of micro-instructions being configured to recover a value of the auxiliary stack pointer to use it as a main stack pointer.

6. The system-on-chip according to claim 1, wherein the power supply controller is configured to
transmit, when leaving the standby power supply mode, a signal to the central processing unit, wherein the signal indicates to the central processing unit that the central processing unit is returning from a standby power supply mode, wherein, in response to receiving the signal, the central processing unit is configured to execute the second sequence of micro-instructions.

7. The system-on-chip according to claim 1, wherein the first sequence of micro-instructions is injected through execution of a goto retention instruction into a processing chain of the central processing unit, and the second sequence of micro-instructions is injected through execution of a release retention instruction into the processing chain of the central processing unit.

8. The system-on-chip according to claim 7, wherein:
the central processing unit is configured to execute the goto retention instruction;
the goto retention instruction, when executed by the central processing unit, causes a state machine to inject the first sequence of micro-instructions into the processing chain of the central processing unit; and
the first sequence of micro-instructions is configured to:
deactivate handling of interruptions by an interruption controller of the central processing unit;
cause storage of the execution context of the interrupted computer program in a standby area of the data memory; and
initiate communication with the power supply controller to request switching into the standby power supply mode.

9. The system-on-chip according to claim 7, wherein:
the central processing unit is configured to execute the release retention instruction;
the release retention instruction, when executed by the central processing unit, causes a state machine to inject the second sequence of micro-instructions into the processing chain of the central processing unit; and
the second sequence of micro-instructions is configured to:
recover data stored in a standby area of the data memory associated with a register bank, control and status registers, and registers for peripherals;
re-establish the recovered data in corresponding registers of the central processing unit;
modify a value of a main stack pointer based on a stored auxiliary stack pointer; and
recover a value of an instruction pointer to resume execution of the interrupted computer program.

10. The system-on-chip according to claim 1, wherein the memories directly coupled to the central processing unit comprise:
the program memory configured to store instructions of the computer program executed by the central processing unit; and
the data memory comprising a main stack configured to store data generated during the execution of the computer program, including temporary data derived from a register bank of the central processing unit, wherein the data memory further comprises a standby area configured to store the execution context of the computer program before the central processing unit switches into the standby power supply mode, the standby area starting at a retention context address known to a control unit of the central processing unit.

11. The system-on-chip according to claim 1, further comprising:
a first power supply switch controlled by the power supply controller and configured to receive the standby supply voltage and to output the standby supply voltage to a power supply domain of the memories when the system-on-chip is in the standby power supply mode; and
a second power supply switch controlled by the power supply controller and configured to receive the normal operation supply voltage and to output the normal operation supply voltage to power supply domains of the central processing unit and the memories when the system-on-chip is in the normal operation power supply mode.

12. The system-on-chip according to claim 1, further comprising:
isolation cells comprised in a power supply domain of the power supply controller, the isolation cells being configured to:
isolate a power supply domain of the central processing unit from other elements of the system-on-chip when electric power supply to the central processing unit is interrupted; and
prevent propagation of floating signals originating from the central processing unit when the central processing unit is no longer electrically powered towards other elements of the system-on-chip.

13. The system-on-chip according to claim 1, wherein the power supply controller is configured to:
receive a retention request signal from a power supply mode controller of the central processing unit to request switching into the standby power supply mode;
transmit an retention acknowledgement signal to the power supply mode controller of the central processing unit accepting the switch to the standby power supply mode after receiving the retention request signal; and
receive a ready signal from the power supply mode controller of the central processing unit indicating readiness to switch into the standby power supply mode after the central processing unit receives the retention acknowledgement signal.

14. An electric power management method for a system-on-chip, the method comprising:
setting, by a power supply controller, a central processing unit and memories in a normal operation power supply mode in which the central processing unit and the memories are powered by a normal operation supply voltage, the system-on-chip comprising the central processing unit, the memories being directly coupled to the central processing unit, and the power supply controller;
executing by the central processing unit a first sequence of micro-instructions before being set in a standby power supply mode, the executing of the first sequence of micro-instructions copying, in a data memory directly coupled to the central processing unit, an execution context of a computer program the execution of which by the central processing unit is interrupted to switch into a standby power supply mode;
setting, by the power supply controller, the central processing unit and the memories in the standby power supply mode in which the central processing unit is not powered and the memories are powered by a standby supply voltage lower than the normal operation supply voltage and sufficient to preserve data stored in the memories;
setting, by the power supply controller, the central processing unit and the memories back to the normal operation power supply mode; and
executing by the central processing unit a second sequence of micro-instructions when leaving the standby power supply mode to recover the execution context stored in the memories in order to resume the execution of the interrupted computer program.

15. The method according to claim 14, further comprising communicating, by a power supply mode controller of the central processing unit, with the power supply controller to negotiate a switch into the standby power supply mode.

16. The method according to claim 15, wherein the communicating comprises:
transmitting, by a power supply mode controller of the central processing unit, a retention request signal to the power supply controller to request switching into the standby power supply mode;
receiving, by the power supply mode controller, a retention acknowledgment signal from the power supply controller accepting the switch to the standby power supply mode; and
transmitting, by the power supply mode controller, a ready signal to the power supply controller indicating readiness of the central processing unit to switch into the standby power supply mode.

17. The method according to claim 14, further comprising executing by the central processing unit micro-instructions supplied by a state machine of a control unit of the central processing unit to:
store the execution context in the data memory directly coupled with the central processing unit before switching into the standby power supply mode, and
recover the execution context in the data memory directly coupled with the central processing unit when leaving the standby power supply mode.

18. The method according to claim 14, further comprising executing, by the central processing unit, instructions to enter and leave the standby power supply mode, these instructions being stored in at least one program memory directly coupled with the central processing unit.

19. The method according to claim 14, further comprising:
storing an auxiliary stack pointer in a register of the central processing unit, the auxiliary stack pointer allowing storing a value of a main stack pointer before switching into a standby power supply mode, the execution of the first sequence of micro-instructions allowing storing the auxiliary stack pointer in the data memory directly coupled to the central processing unit before switching into the standby power supply mode, the execution of the second sequence of micro-instructions allowing recovering a value of the auxiliary stack pointer to use it as a main stack pointer.

20. The method according to claim 19, further comprising:
transmitting, by the power supply controller when leaving the standby power supply mode, a signal to the central processing unit;
wherein the signal indicates to the central processing unit that the central processing unit is returning from the standby power supply mode; and
in response to receiving the signal, executing, by the central processing unit, the second sequence of micro-instructions.

21. A system-on-chip comprising:
a central processing unit,
memories comprising a data memory and a program memory, the memories being directly coupled to the central processing unit, the program memory storing a first sequence of micro-instructions and a second sequence of micro-instructions to be executed in the central processing unit,
a power supply controller configured to set the central processing unit and the memories:
in a normal operation power supply mode in which the central processing unit and the memories are powered by a normal operation supply voltage, and in a standby power supply mode in which the central processing unit is no longer powered and the memories are powered by a standby supply voltage lower than the normal operation supply voltage and sufficient to preserve data stored in the memories, and
wherein the central processing unit is configured to:
execute the first sequence of micro-instructions before being set in a standby power supply mode, the first sequence of micro-instructions when executed enable the central processing unit to copy, in to the data memory directly coupled to the central processing unit, an execution context of a computer program the execution of which by the central processing unit is interrupted to switch into a standby power supply mode, and
execute the second sequence of micro-instructions when leaving the standby power supply mode to recover the execution context stored in the data memory in order to resume the execution of the interrupted computer program.
